(19) United States
(12) Patent Application Publication
(10) Pub. No.: US 2023/0417583 A1
(43) Pub. Date: Dec. 28, 2023

(54) WIDE RANGE MULTI-PHASE FLOW METER

(71) Applicant: SAUDI ARABIAN OIL COMPANY, Dhahran (SA)

(72) Inventor: Salman D. Gamber, Al-Ahsa (SA)

(73) Assignee: SAUDI ARABIAN OIL COMPANY, Dhahran (SA)

(21) Appl. No.: 18/464,031

(22) Filed: Sep. 8, 2023

Related U.S. Application Data
(62) Division of application No. 17/029,879, filed on Sep. 23, 2020.

(51) Int. Cl. G01F 1/44; E21B 47/06; E21B 47/10; G01N 23/046; G01N 23/06

(52) U.S. Cl. CPC G01F 1/44; E21B 47/06; E21B 47/10; G01N 2223/40; G01N 23/06; G01N 2223/04; G01N 23/046

(57) ABSTRACT

A multiphase flow meter (MPFM) for determining component flowrates of multiple component phases within a multiphase mixture having a multiphase flowrate is disclosed. The MPFM may include a first venturi having a first constriction diameter; a second venturi having a second constriction diameter; a gamma ray tomograph fluidly connected to the first venturi and the second venturi; and a tomography controller communicably connected to the gamma ray tomograph. The tomography controller may be configured to calculate a first venturi multiphase flowrate using a first pressure change sensed across the first venturi and a second venturi multiphase flowrate using a second pressure change sensed across the second venturi. Additionally, the tomography controller may be configured to determine the component flowrates of the multiple component phases using a multiphase flowrate calculated from the first venturi multiphase flowrate and the second venturi multiphase flowrate.

### CROSS-REFERENCE TO RELATED APPLICATIONS

This application is a Division of application Ser. No. 17/029,879 filed on Sep. 23, 2020. The entire contents of these applications are incorporated herein by reference in their entirety.

### BACKGROUND

In oil and gas, it is often important to know the volume or mass of each constituent phase within a multiphase fluid mixture. For example, it may be very important to know the relative fractions of water, oil, and gas being produced from a well as well as their individual flowrates. Traditionally, to determine the fraction of each component phase within an overall fluid, the phases first had to be separated using large, slow, expensive pressure vessel separators such as a three-phase separator.

Alternatively, multi-phase flow meters (MPFMs) may instead be used to simultaneously measure the individual fluid flowrates and volume fractions of multiple phases within a multiphase fluid mixture. These MPFMs rely on a variety of modern characterization techniques, including electromagnetic methods such as microwaves, SONAR, gamma ray densitometry, and others.

### SUMMARY OF INVENTION

Some embodiments may describe a multiphase flow meter (MPFM) for determining component flowrates of multiple component phases within a multiphase mixture having a multiphase flowrate. The MPFM may comprise a first venturi having a first constriction diameter; a second venturi having a second constriction diameter; a gamma ray tomograph fluidly connected to the first venturi and the second venturi; and a tomography controller communicably connected to the gamma ray tomograph. In some embodiments, the tomography controller may be configured to calculate a first venturi multiphase flowrate using a first pressure change sensed across the first venturi and a second venturi multiphase flowrate using a second pressure change sensed across the second venturi. In some embodiments, the tomography controller may also be configured to determine the component flowrates of the multiple component phases using a multiphase flowrate calculated from the first venturi multiphase flowrate and the second venturi multiphase flowrate.

In some embodiments, the multi-phase flow meter may further comprise a fluid inlet into which the multiphase mixture enters the MPFM and a fluid outlet out of which the multiphase mixture exits the MPFM.

In some embodiments, the multi-phase flow meter may further comprise a blind T-bend that is fluidly connected to and upflow from the gamma ray tomograph. In some embodiments, the blind T-bend may be configured such that the multiphase mixture flows roughly vertically upward when downflow from the blind T-bend.

In some embodiments, the first constriction diameter may be smaller than the second constriction diameter.

In some embodiments, the multi-phase flow meter may further comprise a first pressure sensor disposed proximate to a first venturi inlet; a second pressure sensor disposed within or proximate to a first constriction; a third pressure sensor disposed proximate to a second venturi inlet; and a fourth pressure sensor disposed within or proximate to a second constriction. In some embodiments, the first pressure change may be determined between the second pressure sensor and the first pressure sensor. In some embodiments, the second pressure change may be determined between the fourth pressure sensor and the third pressure sensor.

In some embodiments, the gamma ray tomograph may comprise a gamma ray source disposed adjacent to one of the first or the second venturi that generates a gamma ray orthogonal to a flow direction in the one of the first or the second venturi. In some embodiments, the gamma ray tomograph may also comprise a gamma ray detector disposed so as to detect the gamma ray generated by the gamma ray source.

In some embodiments, the gamma ray tomograph may comprise a gamma ray source disposed adjacent to a sensor tube of the gamma ray tomograph that generates a gamma ray orthogonal to a flow direction in the sensor tube. In some embodiments, the gamma ray tomograph may also comprise a gamma ray detector disposed so as to detect the gamma ray generated by the gamma ray source.

In some embodiments, the tomography controller may determine a water volume fraction, a gas volume fraction, and an oil volume fraction of the multiphase mixture.

In some embodiments, the first venturi may be a supplemental venturi that is added to the second venturi that may be previously installed in a wellbore.

In some embodiments, a ratio between the first and second venturi constriction diameters may be between 0.10 and 0.80.

In some embodiments, a ratio between the first constriction diameter and a first inlet diameter may be between 0.10 and 0.70.

In some embodiments, a ratio between the second constriction diameter and a second inlet diameter may be between 0.40 and 0.90.

Some embodiments may describe a method for operating a multi-phase flow meter (MPFM) to determine component flowrates of multiple component phases within a multiphase mixture having a multiphase flowrate. Some embodiments of the method may comprise flowing the multiphase mixture through the MPFM into a fluid inlet, through a first venturi, a gamma ray tomograph, and a second venturi, and out a fluid outlet of the MPFM. Some embodiments of the method may also comprise calculating a first venturi multiphase flowrate using a first pressure change measured across the first venturi, calculating a second venturi multiphase flowrate using a second pressure change measured across the second venturi, and determining the multiphase flowrate using the first and the second venturi multiphase flowrates. Some embodiments of the method may comprise determining the component flowrates of the multiple component phases using the multiphase flowrate and a gamma ray data signal generated by a gamma ray detector of the MPFM.

In some embodiments, a range of measurement of the multiphase flowrate by the MPFM may be between 500 barrels per day (BPD) and 14,000 BPD.

In some embodiments, determining the multiphase flowrate may further comprise applying a predetermined flowrate threshold to select the first or the second venturi multiphase flowrates to determine the multiphase flowrate.

In some embodiments, determining the multiphase flowrate may further comprise applying a predetermined pressure change threshold to select the first or the second venturi multiphase flowrates to determine the multiphase flowrate.

In some embodiments, determining the multiphase flowrate may further comprise determining a difference between the first venturi multiphase flowrate and the second venturi multiphase flowrate and using the difference to select between the first venturi multiphase flowrate and the second venturi multiphase flowrate to determine the multiphase flowrate.

In some embodiments, determining the multiphase flowrate may further comprise equating the multiphase flowrate with one of the first or the second multiphase flowrate reflecting a larger constriction diameter and equating the multiphase flowrate with an other of the first or the second multiphase flowrate after the first and the second multiphase flowrates diverge.

In some embodiments, determining the multiphase flowrate may further comprise equating the multiphase flowrate with one of the first or the second multiphase flowrate reflecting a larger constriction diameter and equating the multiphase flowrate with an other of the first or the second multiphase flowrate after the first and the second multiphase flowrates converge.

In some embodiments, determining the multiphase flowrate may further comprise applying input from an electric submersible pump fluidly connected to the MPFM to select the first or the second multiphase flowrate.

Other aspects and advantages will be apparent from the following description and the appended claims.

### BRIEF DESCRIPTION OF DRAWINGS

FIG. 1 depicts a schematic of a multi-phase flow meter (MPFM) according to one or more embodiments.

FIGS. 2A-2C depict schematics of the geometry of various embodiments of a venturi.

FIGS. 3A-3C depict schematics of the pressure sensor locations for various embodiments of a venturi.

FIG. 4 depicts a schematic of an MPFM according to one or more embodiments.

FIG. 5 depicts a schematic of an MPFM according to one or more embodiments.

FIG. 6 depicts a method flow chart according to one or more embodiments.

FIG. 7 depicts a schematic graph of output from an MPFM according to one or more embodiments.

FIG. 8 depicts a schematic graph of output from an MPFM according to one or more embodiments.

Throughout the figures, similar numbers are typically used for similar components.

In the figures, down is toward or at the bottom and up is toward or at the top of the figure. “Up” and “down” are generally oriented relative to a local vertical direction. However, as used throughout this disclosure, the terms “upflow” and “downflow” may refer to a position relative to the general direction of process or fluid flow, with upflow indicating a direction or position closer to start of the process and downflow referring to the direction or position closer to the end of the process. One of ordinary skill in the art would readily understand that an object or a process may be upflow or downflow of another object or process while having no general relation to the position relative to vertical orientation unless otherwise specifically stated.

### DETAILED DESCRIPTION

Multi-phase flow meters (MPFM) often rely on gamma ray tomography to dynamically measure droplet size and velocity within a flowing fluid. These tomography results along with other measurements such as density, pressure, temperature, and overall fluid flowrate may be entered into specialized fluid flow models to determine the individual flowrates of each component.

Gamma ray MPFMs are superior to other MPFM technologies because they may be used with multiphase mixtures having a gas volume fraction (GVF) over 95% percent, can more accurately determine the GVF, can directly measure fluid density, and can improve interpretation of intermittent flow (for example, plug and slug type flows).

Embodiments disclosed herein describe a gamma ray tomography-based, dual venturi MPFM. Specifically, the MPFM includes a gamma ray tomograph located between two venturi having different inner diameters to accommodate a wider range for measuring three phase fluid rates. Further, one or more embodiments propose to install double venturis in existing single venturi MPFMs to accommodate high and low range flowrate measurement, without the need to replace or resize existing meters.

An MPFM may be located in line with a production well to measure the composition of the production effluent. Thus, MPFMs may be deployed adjacent to or near a well, such as on the well pad or subsea. The MPFM may be located within about 50 meters from a well head.

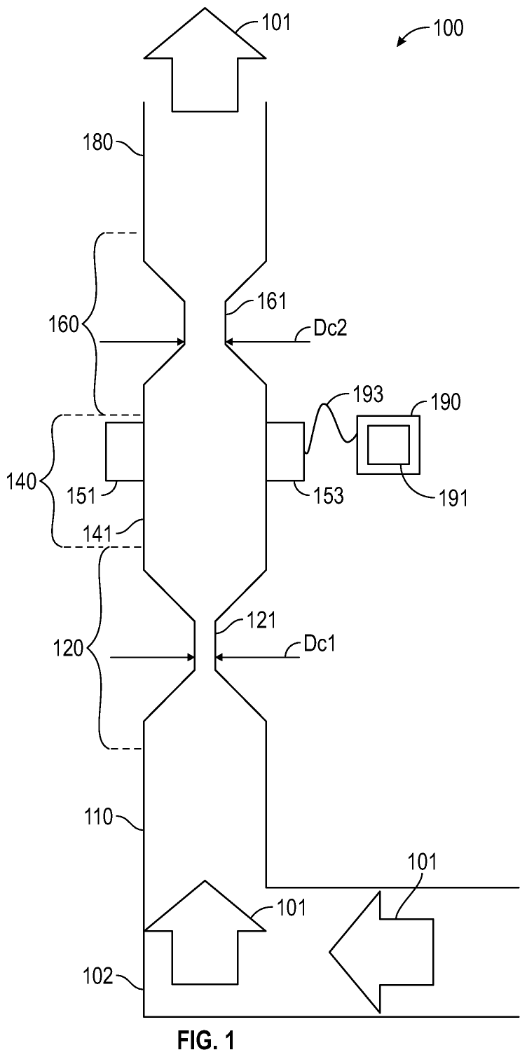

FIG. 1 depicts an embodiment of a MPFM 100 through which a multiphase mixture flows, as is depicted with an arrow 101.

Fluid of the multiphase mixture 101 enters MPFM 100 via a fluid inlet 110 and ultimately exists the MPFM 100 via a fluid outlet 180. Fluidly connected between the fluid inlet 110 and the fluid outlet 180 are a first venturi 120, a gamma ray tomograph 140, and a second venturi 160. A tomography control system 190 including a tomography controller 191 is communicably connected to the gamma ray tomograph 140 via a data connection 193.

The direction of the multiphase mixture flow is indicted with arrows 101 at both the fluid inlet 110 and the fluid outlet 180. Thus, in one or more embodiments, the multiphase mixture 101 flows through the MPFM 100 sequentially through the fluid inlet 110, the first venturi 120, the gamma ray tomograph 140, the second venturi 160, and the fluid outlet 180.

A venturi is a region of a pipe where fluid flow is restricted or choked. Due to Bernoulli's principle, a flow restriction results in a reduction of the fluid pressure within the restriction that is mathematically related to the flowrate of the fluid through the restriction. Consequently, a venturi may be used to measure the flowrate of a fluid, such as a multiphase mixture flowing through such a device. A flow meter that employs a venturi to measure the flowrate of a fluid may be called a venturi meter.

In the MPFM 100, the first venturi 120 has a first venturi throat 121 with a first constriction diameter Dc1. Similarly, the second venturi 160 has a second venturi throat 161 with a second constriction diameter Dc2. In FIG. 1, the first constriction diameter Dc1 is smaller than the second constriction diameter Dc2. Those skilled in the art will appreciate that although the first venturi 120 is shown with the smaller diameter, the MPFM 100 may be arranged such that the first venturi 120 has a larger diameter than the second venturi 160.

The gamma ray tomograph 140 is located between the first venturi 120 and the second venturi 160. The gamma ray tomograph 140 as depicted in FIG. 1 includes a sensor tube 141, a gamma ray source 151, and a gamma ray detector 153. The sensor tube 141 of the gamma ray tomograph 140 fluidly connects the first venturi 120 to the second venturi 160.

The number and the energy of the gamma rays that successfully transmit from the gamma ray source 151 to the gamma ray detector 153 depend on the composition of the multiphase mixture 101 flowing within the sensor tube 141. To that end, water is a strong absorber of gamma rays and gas is a weak absorber of gamma rays. Consequently, the gamma ray tomograph 140 generates a data signal that reflects the transmitted gamma rays. This data signal may be one of the inputs used to determine the composition of the multiphase mixture 101. Additional details about this calculation are discussed below.

In FIG. 1, the gamma ray source 151 is located adjacent to the sensor tube 141 and generates a gamma ray that may be detected by the gamma ray detector 153. Specifically, the gamma ray source 151 generates a gamma ray roughly orthogonal to the direction of the multiphase mixture 101 flow. In one or more embodiments, the gamma ray source 151 may use any radioactive, gamma ray producing materials known in the art to generate the gamma ray, such as americium 241, barium 133, cesium 137, or a combination.

The gamma ray detector 153 is configured to detect the transmitted gamma rays. In one or more embodiments, the gamma ray detector 153 may be located across the sensor tube 141 from the gamma ray source 151. The gamma ray detector 153 may detect some fraction of the gamma rays generated by the gamma ray source 151. The gamma rays detected by the gamma ray detector 153 may have a different energy than the source gamma rays emitted by the gamma ray source 151. In one or more embodiments, the gamma ray detector 153 is configured to generate a gamma ray data signal depending upon the detected gamma rays and transmit the gamma ray data signal to the tomography controller 191.

The gamma ray tomograph 140 disclosed herein may employ various technologies in the gamma ray source 151, the gamma ray detector 153, or both. In one or more embodiments, the gamma ray tomograph 140 may be a scanning tomograph. Thus, in one or more embodiments, the gamma ray source 151 may be configured to emit gamma rays through a range of angles around the sensor tube 141, and the gamma ray detector 153 may be configured to detect gamma rays through a range of angles around the sensor tube 141. Alternatively, in one or more embodiments, the gamma ray tomograph 140 may be an instant, non-scanning tomograph. In one or more embodiments, the gamma ray tomograph 140 may include more than one gamma ray source 151, and correspondingly, more than one gamma ray detector 153.

The sampling frequency is the frequency at which measurements are performed by a measurement device. In the depiction of FIG. 1, the sampling frequency is the frequency at which gamma rays are measured by the gamma ray detector 153. The sampling frequency of the gamma ray detector 153 may vary. In one or more embodiments, the sampling frequency of the gamma ray detector 153 may be once per second or faster.

In one or more embodiments, the gamma ray source 151, the gamma ray detector 153, or both may essentially occupy a single point, a wider arc, or essentially the entire circumference around the sensor tube 141.

Gamma ray absorption is the energy difference between the incoming gamma ray from the gamma ray source 151 and the detected gamma ray at the gamma ray detector 153. In one or more embodiments, the gamma ray tomograph 140 may rely on single or multiple gamma ray absorption.

In FIG. 1, the tomography control system 190 is communicatively connected to the gamma ray tomograph 140 (specifically the gamma ray detector 153) via the data connection 193. As depicted in FIG. 1, in one or more embodiments, the tomography control 191 may be communicably connected to the gamma ray detector 153 via the data connection 193. In one or more embodiments, the gamma ray detector 153 may send a gamma ray data signal to the tomography controller 191. In one or more embodiments, the tomography controller 191 may be communicably connected to the gamma ray source 151 via a data connection (not depicted). In one or more embodiments, the tomography controller 191 may control the gamma ray source 151. In one or more embodiments, the tomography controller 191 may be communicably connected to both the gamma ray source 151 and the gamma ray detector 153 via one or more data connections (not depicted).

In one or more embodiments, although not shown, the tomography control system 190 includes one or more processors and a computer-readable medium that stores computer instructions executable by the processors. The tomography control system 190 includes the tomography controller 191 that interprets the received measurement data into outputs relating to fluid characteristics of the multiphase mixture, such as density, temperature, pressure, viscosity, a combination of these characteristics, or other characteristics.

In one or more embodiments, the tomography control system 190, the tomography controller 191, or both may be a microcontroller, a computer (such as a personal computer, minicomputer, workstation, or mainframe), a dedicated controller (such as a programmable logic controller), or a combination thereof.

In one or more embodiments, the data connection 191 may be a wire, a data cable (such as a coaxial cable, a multi-core cable, a ribbon cable, an Ethernet cable, a token ring cable, an optical fiber cable, a serial cable, or a USB cable), a wireless connection (such as Wi-Fi or Bluetooth) or any other wired or wireless data connection 191 known in the art.

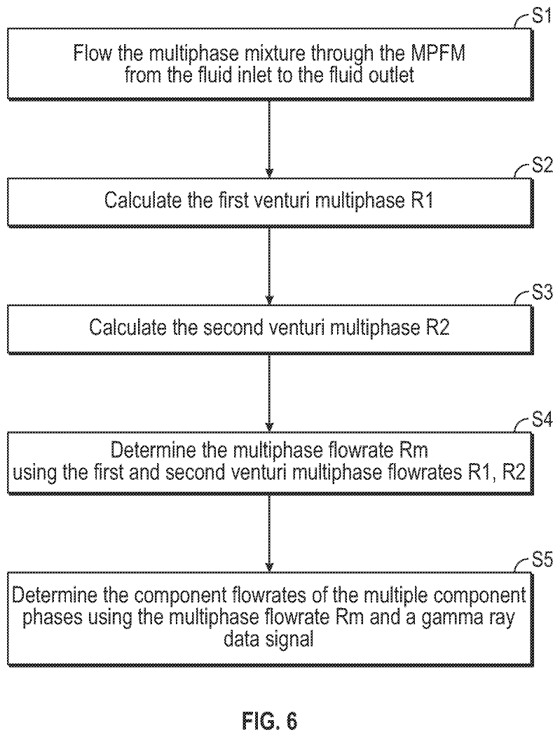

In one or more embodiments, the multiphase mixture 101 passing through the MPFM 100 may be a mixture of multiple component phases. Each component phase of the multiphase mixture 101 has a component flowrate, a component volume fraction, and a component mass fraction. In one or more embodiments, the MPFM 100 may measure the component flowrate for each of the component phases within the multiphase mixture 101 flow. The method for determining the component flowrates of each component phase within the multiphase mixture 101 using the MPFM 100 is discussed in detail in FIG. 6 below.

In one or more embodiments, the multiphase mixture 101 may contain a polar liquid, such as water. Specifically, the multiphase mixture 101 may contain water having a water volume fraction (WVF). The water within the multiphase mixture 101 may contain dissolved solids (such as dirt), ions (such as dissolved salts), or a combination thereof. In one or more embodiments, the multiphase mixture 101 may contain brackish water or ocean water.

In one or more embodiments, the multiphase mixture 101 may contain a gas having a gas volume fraction (GVF). “Gas” here may be used to describe a mixture of one or more gases, such as wet natural gas. In one or more embodiments, the gas within the multiphase mixture 101 may be a mixture of hydrocarbon gas(es) (such as methane or ethane) and non-hydrocarbon gas(es) (such as carbon dioxide or water vapor).

In one or more embodiments, the multiphase mixture 101 may contain a non-polar liquid, such as a non-aqueous liquid. In one or more embodiments, the multiphase mixture 101 may contain oil. “Oil” here may be used to describe a mixture of one or more hydrocarbon liquid(s) such as crude oil. In one or more embodiments, the multiphase mixture 101 may contain oil having an oil volume fraction (OVF).

In one or more embodiments, the multiphase mixture 101 that flows through the MPFM 100 may contain two or more immiscible component phases (for example, oil and water). In one or more embodiments, the multiphase mixture 101 may include two or more of a polar liquid (such as water), a non-polar liquid (such as oil), or a gas. One or more component phases of the multiphase mixture 101 may be a homogeneous mixture (for example, crude oil). In one or more embodiments, the multiphase mixture 101 may be may be a mixture of two or more immiscible component phases whose distribution is heterogeneous (for example, clustered bubbles of gas within a liquid). Alternatively, the multiphase mixture 101 may be a mixture of two or more immiscible component phases whose distribution is roughly homogeneous (for example, a mixture of oil and gas where the gas bubbles within the oil have a roughly uniform size and have a roughly even spatial distribution). In one or more embodiments, the multiphase mixture 101 may be a heterogeneous mixture composed of one or more homogeneous mixtures (for example, an immiscible mixture of brackish water in crude oil).

In one or more embodiments, the multiphase mixture 101 flowing through the MPFM 100 may be a three-phase mixture of water, gas, and oil. More specifically, the MPFM 100 may measure a water volume fraction (WVF), a gas volume fraction (GVF), and an oil volume fraction (OVF) of the multiphase mixture 101. The method for determining the WVF, OVF, and GVF using the MPFM 100 will be discussed in FIG. 6 below.

In one or more embodiments, the multiphase mixture 101 flowing through the MPFM 100 may have a steady-state flow, a variable flow, or an intermittent flow (for example, plug and slug type flows).

In one or more embodiments, MPFM 100 may include a blind t-bend 102. A blind t-bend 102 is a fluid component where the incoming flow cannot continue directly ahead because of a dead-end and instead the flow must be rerouted through a 90° turn. A blind t-bend 102 may be used to homogenize the multiphase mixture 101. In one or more embodiments, the blind t-bend 102 may be upflow from the gamma ray tomograph or the first venturi. The blind t-bend 102 may be fluidly located between the fluid inlet and the first venturi or between the first venturi and the gamma ray tomograph.

In one or more embodiments, MPFM 100 may be configured such that, downflow from the blind t-bend 102 (upon exiting the blind t-bend 102), the multiphase mixture 101 may be flowing roughly vertical. More generally, the multiphase mixture within at least one of the first venturi, the gamma ray tomograph, and the second venturi may be flowing roughly vertical. Here, “roughly vertical” may mean less than 10° off of vertical (such as less than 5° off of vertical, less than 7.5° off of vertical, less than 1° off of vertical, and so on).

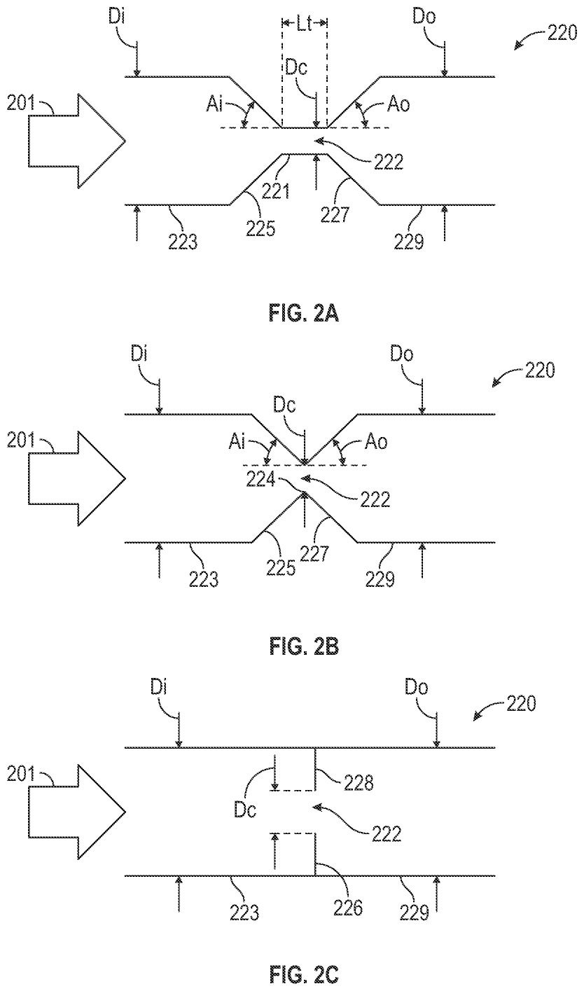

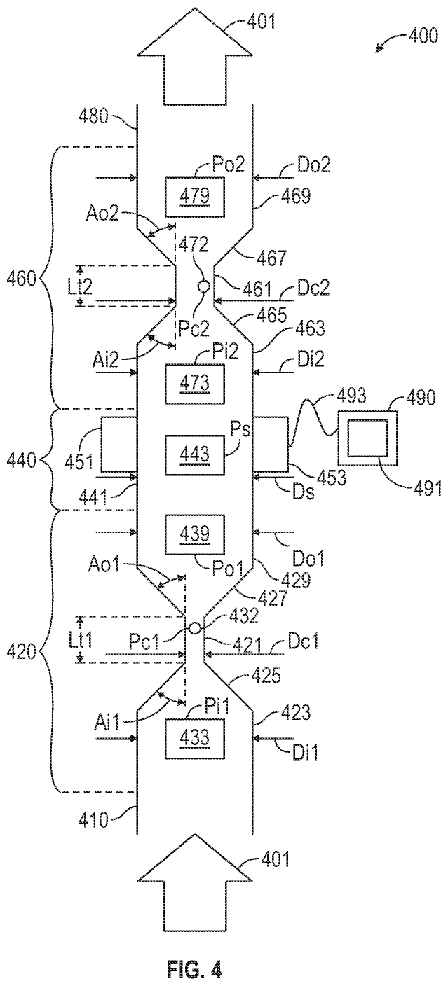

As noted above, the MPFM of FIG. 1 depicts two venturis (120, 160) before and after the gammy ray tomograph 140. These venturis (120, 160) have different constriction diameters Dc1 and Dc2. Details of the venturis and associated parameters and dimensions are shown in FIGS. 2A-2C, which depict various embodiments of a venturi 220. Any of the embodiments depicted in FIGS. 2A-2C could be a first venturi (for example, 120 in FIG. 1), a second venturi (for example, 160 in FIG. 1) or both (see FIGS. 1 and 4). Each of the venturis 220 shown in FIGS. 2A-2C has a venturi inlet 223 having a venturi inlet diameter Di and a venturi outlet 229 having a venturi outlet diameter Do. A multiphase mixture 201 entering the venturi 220 is indicated with an arrow.

When flowing from venturi inlet 223 to venturi outlet 229, the maximum constriction of the multiphase mixture 201 occurs where the diameter of the venturi 220 is the smallest. The smallest diameter of the venturi 220 is located at a venturi constriction 222. A venturi constriction diameter Dc is measured within the venturi constriction 222. The venturi constriction 222 may be defined by many different components of venturi 220. Thus, one or more embodiments of the venturi 220 and the venturi constriction 222 are depicted in FIGS. 2A-2C and discussed below.

FIG. 2A depicts an embodiment of the venturi 220 in the form of a “throat-type” venturi 220. Here, a venturi throat 221 with an elongated shape serves to constrict the multiphase mixture 201 flow through the venturi 220. Thus, the venturi constriction 222 is defined by the venturi throat 221. The venturi constriction diameter Dc is measured within the venturi construction 222 and, thus, within the venturi throat 221. A venturi inlet cone 225 directs fluid from the venturi inlet 223 and into the venturi throat 221. A venturi outlet cone 227 directs fluid out of the venturi throat 221 into the venturi outlet 229.

In FIG. 2A, the multiphase mixture 201 flows sequentially through the venturi 220 from the venturi inlet 223, through the venturi inlet cone 225, the venturi constriction 222 defined by the venturi throat 221, and the venturi outlet cone 227, and out the venturi outlet 229.

A venturi throat length Lt may be measured along the venturi throat 221. A venturi inlet angle Ai may be measured between the venturi inlet cone 225 and the venturi throat 221. A venturi outlet angle Ao may be measured between the venturi outlet cone 227 and the venturi throat 221. In one or more embodiments, venturi inlet angle Ai may be between about 5° and 30° (such as between 7° and 15°, between 9° and 12°, etc.). In one or more embodiments, venturi outlet angle Ao may be between about 1° and 30° (such as between 2.5° and 20°, 2.5° and 10°, etc.). In one or more embodiments, venturi throat length Lt may be between 50 millimeters (mm) and 75 mm.

One having ordinary skill in the art will appreciate that the venturi inlet angle Ai and the venturi outlet angle Ao may be designed so as to avoid undue aerodynamic drag through the venturi 220. In one or more embodiments, venturi inlet angle Ai may be greater than, less than, or roughly equal to the venturi outlet angle Ao.

FIG. 2B depicts an embodiment of the venturi 220 in the form of a “notch-type” venturi 220. Between the venturi inlet cone 225 and the venturi outlet cone 227, a V-shaped notch forms the venturi constriction through which fluid flow passes. In FIG. 2B, the venturi inlet cone 225 directly, fluidly connects to the venturi outlet cone 227 at an interface 224. In one or more embodiments, the interface 224 may be smooth or angular.

The smallest diameter of the venturi 220 is located at the interface 224 between the venturi inlet cone 225 and the venturi outlet cone 227. Therefore, the venturi constriction 222 of FIG. 2B is defined by the interface 224 where the venturi inlet cone 225 meets the venturi outlet cone 227. The venturi constriction diameter Dc is measured within the venturi constriction 222 and, thus, at the interface 224.

The venturi inlet cone 225 directs fluid from the venturi inlet 223 into the venturi constriction 222 The venturi outlet cone 227 serves both to direct fluid from the venturi constriction 222 into the venturi outlet 229 and to define the venturi constriction 222.

In FIG. 2B, the multiphase mixture 201 flows sequentially through the venturi 220 from the venturi inlet 223, through the venturi inlet cone 225, the venturi constriction 222 defined by the interface 224, and the venturi outlet cone 227, and out the venturi outlet 229.

In the venturi design of FIG. 2B, the venturi inlet angle Ai may be measured between the venturi inlet cone 225 and a line tangent to the interface 224. The venturi outlet angle Ao may be measured between the venturi outlet cone 227 and a line tangent to the interface 224.

FIG. 2C depicts an embodiment of a venturi 220 in the form of a “orifice-type” venturi 220. This venturi 220 differs from the venturi 220 depicted in FIGS. 2A and 2B in that it lacks the venturi inlet cone 225, the venturi throat 221, and the venturi outlet cone 227. Instead, located between the venturi inlet 223 and the venturi outlet 229 is a venturi orifice plate 226 perforated by an orifice 228. In one or more embodiments, the orifice 228 boundary may be smooth or angular.

The smallest diameter of the venturi 220 the orifice 228 defined by the venturi orifice plate 226. Therefore, in FIG. 2C, the venturi constriction 222 is equivalent to the orifice 228. Additionally, the venturi constriction 222 is similarly defined by the venturi orifice plate 226. The venturi constriction diameter Dc is measured within the venturi constriction 222 and, thus, is equal to the diameter of the orifice 228. For clarity, the orifice 228 points to the boundary of the orifice 228 as defined by the venturi orifice plate 226, while the venturi constriction 222 points to the opening in the venturi orifice plate 226.

In FIG. 2C, the multiphase mixture 201 flows sequentially through the venturi 220 from the venturi inlet 223, through the venturi constriction 222 defined by the venturi orifice plate 226, and out the venturi outlet 229.

In addition to the configurations depicted in FIGS. 2A-2C, further configurations of the venturi 220 and the venturi constriction 222 will be apparent to one having skill in the art. Any suitable venturi 220 configuration, now known or later developed, may be employed in the MPFM described herein and shown in FIGS. 1 and 4.

Continuing with FIGS. 2A-2C, in one or more embodiments, within a single venturi 220, venturi inlet diameter Di may be essentially equal to the venturi outlet diameter Do. Alternatively, in one or more embodiments, within a single venturi 220, the venturi inlet diameter Di may not be equal to the venturi outlet diameter Do, and may be smaller or larger than the venturi outlet diameter Do. In one or more embodiments, the venturi inlet diameter Di may be between 75 mm and 125 mm. In one or more embodiments, the venturi outlet diameter Do may be between 75 mm and 125 mm.

In one or more embodiments, within a single venturi 220, the venturi constriction diameter Dc may be less than the venturi inlet diameter Di, the venturi outlet diameter Do, or both. In one or more embodiments, the venturi constriction diameter Dc may be between 10 mm and 90 mm (such as between 15 and 75 mm, between 20 mm and 65 mm, etc.). In one or more embodiments, the venturi constriction diameter Dc may be between 10% and 90% smaller than the venturi inlet diameter Di (such as between 15% and 75% smaller, between 20% and 65% smaller, etc.). In one or more embodiments, the venturi constriction diameter Dc may be between 10% and 90% smaller than the venturi outlet diameter Do (such as between 15% and 75% smaller, between 20% and 65% smaller, etc.).

Some embodiments of the venturi 220 of FIG. 2A-2C may include one or more transitions such as those between the venturi inlet 223 and the venturi inlet cone 225, between the venturi inlet cone 225 and the venturi throat 221, between the venturi throat 221 and the venturi outlet cone 227, and/or between the venturi outlet cone 227 and the venturi outlet 229. In one or more embodiments, transitions within the venturi 220 may be smooth, angular, or a combination.

In some embodiments, a “throat-type” venturi 220 as depicted in FIG. 2A may generate less turbulence than a “notch-type” venturi 220 as depicted in FIG. 2B or a “orifice-type” venturi 220 as depicted in FIG. 2C.

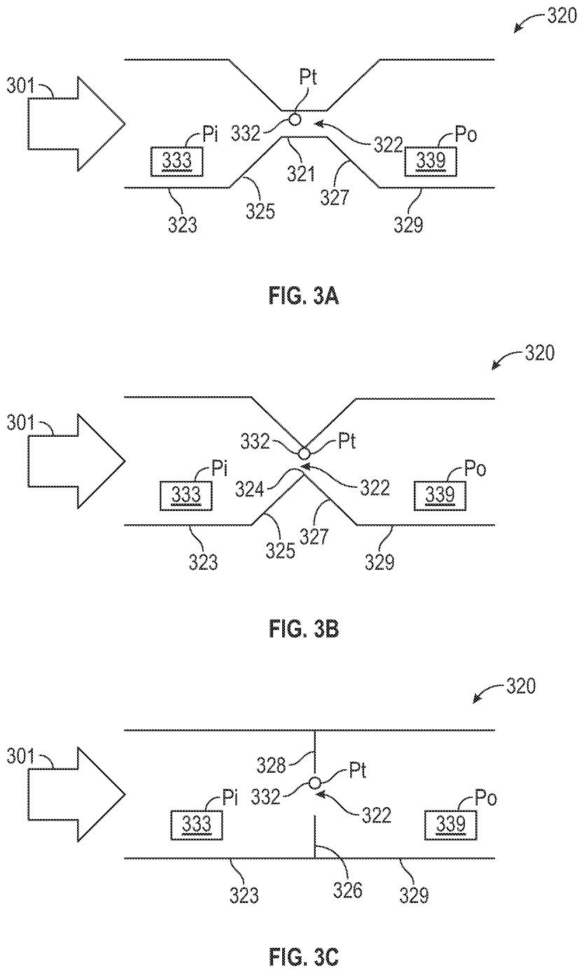

FIGS. 3A-3C depict various forms of venturis 320 as depicted in FIGS. 2A-2C: a throat-type venturi, a notch-type venturi, and an orifice-type venturi, respectively. Similar to FIGS. 2A-2C, in FIGS. 3A-3C a multiphase mixture 301 flows into a venturi inlet 323 and out a venturi outlet 329. A venturi constriction 322 indicates the location of the narrowest diameter within the venturi 320. FIGS. 3A and 3B include a venturi inlet cone 325 and a venturi outlet cone 327. FIG. 3A depicts the venturi 320 where the venturi constriction 322 is defined by a venturi throat 321, an elongated structure in the center of the venturi 320. FIG. 3B depicts the venturi 220 where the venturi constriction 322 is defined by an interface 324 between the venturi inlet cone 325 and the venturi outlet cone 327. FIG. 3C depicts the venturi 320 that includes a venturi orifice plate 326 perforated by an orifice 328 where the venturi constriction 322 is equivalent to the orifice 328. Such a venturi 320 as depicted in FIGS. 3A-3C may be a first venturi, a second venturi, or both as depicted in FIGS. 1 and 4.

FIGS. 3A-3C depict potential locations of multiple pressure sensors that may be incorporated into one or more embodiments of the venturi 320. For example, FIGS. 3A-3C depict a venturi inlet pressure sensor 333 that measures a venturi inlet pressure Pi, a venturi outlet pressure sensor 339 that measures a venturi outlet pressure Po, and a venturi constriction pressure sensor 332 that measures a venturi constriction pressure Pc. Again, similar to the location of the venturi constriction 322, the venturi constriction pressure sensor 332 may be located within the narrowest section of the venturi 320, whether or not the venturi 320 has a discrete venturi throat 321.

Venturi 320 may include one or more pressure sensors 332, 333, 339 that measure the venturi inlet pressure Pi, the venturi outlet pressure Po, the venturi throat pressure Pt, or a combination. In one or more embodiment, the pressure sensors (332, 333, 339) may have a sampling rate of one or more times per second.

In one or more embodiments, the pressure sensor(s) 333, 332, 339 in the venturi 320 may be able to measure pressures ranging from between 1 pound per square inch (psi) and 100 psi (such as between 2 psi and 75 psi, between 3 psi and 40 psi, etc.).

The pressure sensor(s) 333, 332, 339 within the venturi 320 may be of any suitable type. For example, the pressure sensor(s) 333, 332, 339 within the venturi 320 may be piezoresistive strain gauge, capacitive, electromagnetic, strain-gauge, optical, potentiometric, force balancing, resonant, thermal, ionization, or any suitable combination thereof.

One having ordinary skill in the art will appreciate how one or more types of pressure sensor(s) 333, 332, 339 may be implemented in the venturi 320. In one or more embodiments, one or more pressure sensor(s) 333, 332, 339 within the venturi 320 may be an absolute pressure sensor, a gauge pressure sensor, a vacuum pressure sensor, a differential pressure sensor, a sealed pressure sensor, or a combination. Further, one having ordinary skill in the art will readily understand that the locations of the pressure sensors are not limited to the arrangement shown in FIGS. 3A-3C. The pressure sensors may be located anywhere inside or outside the venturi, without departing from the scope as disclosed herein, as long as the pressure in desired areas is able to be measured. In one or more embodiments, one or more of the pressure sensor(s) 333, 332, 339 may be a differential pressure sensor that measures a pressure difference between the venturi inlet pressure Pi and the venturi outlet pressure Po, between the venturi inlet pressure Pi and the venturi constriction pressure Pc, between the venturi constriction pressure Pc and the venturi outlet pressure Po, or a combination. In one or more embodiments, the pressure sensor(s) 333, 332, 339 may be absolute pressure sensor(s), vacuum pressure sensor(s), or a combination of such sensors that measure an absolute pressure (relative to vacuum) for the venturi inlet pressure Pi, the venturi constriction pressure Pc, the venturi outlet pressure Po, or a combination. In one or more embodiments, the pressure sensor(s) 333, 332, 339 may be gauge pressure sensor(s), sealed pressure sensor(s), or a combination that measure a pressure relative to a common standard (such as atmospheric pressure or another reference pressure) for the venturi inlet pressure Pi, the venturi throat pressure Pt, the venturi outlet pressure Po, or a combination.

In one or more embodiments, the pressure sensor(s) 333, 332, 339 within the venturi 320 may withstand and function under the environmental conditions present downhole in an oil and gas well. Some environmental conditions that may be present include an elevated temperature (up to 300° C.), a chemically corrosive environment, and other environmental conditions known to those of ordinary skill in the art.

A multiphase flowrate through the venturi 320 may be calculated using one or more equations, which vary depending upon the venturi 320 geometry and the location of the pressure sensors 333, 332, 339. These equations relate a pressure change across the venturi 320 to the multiphase flowrate of the multiphase mixture 301 through said venturi 320.

In one or more embodiments, the multiphase flowrate equations may depend on the overall configuration and geometry of venturi 320. In one or more embodiments, these multiphase flowrate equations may differ for a venturi 320 in the form of a throat-type venturi as in FIG. 3A; a venturi 320 in the form of a notch-type venturi as in FIG. 3B; and a venturi in the form of an orifice-type venturi as in FIG. 3C. Further, the multiphase flowrate equations may depend on the placement of the pressure sensors 333, 332, 339 that measure a pressure change across a venturi 320. In one or more embodiments, the multiphase flowrate equations may depend on the venturi inlet pressure Pi, the venturi constriction pressure Pc, or the venturi outlet pressure Po, or a combination.

In one or more embodiments, a pressure change across the venturi 320 may be calculated using the venturi inlet pressure Pi and the venturi outlet pressure Po. Alternatively, in one or more embodiments, a pressure change across the venturi 320 may be calculated using the venturi inlet pressure Pi and the venturi constriction pressure Pc. In one or more embodiments, a pressure change across the venturi 320 may be calculated using the venturi constriction pressure Pc and the venturi outlet pressure Po. Bernoulli's Principal may be used to calculate the multiphase volumetric flowrate (Q), using:

$$Q = π \frac{{Di}^{2}}{4} \sqrt{\frac{2}{ρ} \cdot \frac{Pi - Pc}{{( \frac{Di}{Dc} )}^{2} - 1}} ,$$

where ρ is the density of the multiphase fluid, Pi and Pc are the venturi inlet and constriction pressures, and Di and Dc are the venturi inlet and constriction diameters. One having skill in the art will appreciate how Bernoulli's principal may be adjusted to calculate the multiphase volumetric flowrate using venturi inlet pressure Pi and the venturi outlet pressure Po or venturi constriction pressure Pc and the venturi outlet pressure Po. Further, one having skill will appreciate how calculations based on Bernoulli's principal may be adjusted to compensate for the effects of molar mass, temperature, and pressure on density and concentration.

FIG. 4 depicts a more detailed version of the MPFM of FIG. 1. Many of the same measurements and values (e.g., diameters, angles, etc.) described in FIG. 1 are shown with respect to FIG. 4. Those skilled in the art will appreciate that these values may be the same as those described above.

In FIG. 4, a multiphase mixture 401 enters a MPFM 400 via a fluid inlet 410 and ultimately exits the MPFM 400 via a fluid outlet 480. Fluidly connected between the fluid inlet 410 and the fluid outlet 480 are a first venturi 420, a sensor tube 441 of a gamma ray tomograph 440, and a second venturi 460. A tomography control system 490 including a tomography controller 491 is communicably connected to the gamma ray tomograph 440 via a data connection 493. The gamma ray tomograph 440 also includes a gamma ray source 451 and a gamma ray detector 453. Sensor tube 441 has a sensor tube diameter Ds.

In the MPFM 400 depicted in FIG. 4, both the first venturi 420 and the second venturi 460 have the form of a “throat-type venturi” as depicted in FIG. 2A. In one or more embodiments, the first venturi 420, the second venturi 460, of both may have the form a “throat-type venturi” as depicted in FIG. 2A, a “notch-type venturi,” as depicted in FIG. 2B, a “orifice-type venturi” as depicted in FIG. 2C, or any other venturi geometry known in the art.

The first venturi 420 has a first venturi inlet 423 with a first venturi inlet diameter Di1, a first venturi inlet cone 425 with a first venturi inlet angle Ai1, a first venturi throat 421 with a first venturi constriction diameter Dc1, a first venturi outlet cone 427 with a first venturi outlet angle Ao1, and a first venturi outlet 429 with a first venturi outlet Do1. Similarly, the second venturi 460 has a second venturi inlet 463 with a second venturi inlet diameter Di2, a second venturi inlet cone 465 with a second venturi inlet angle Ai2, a second venturi throat 461 with a second venturi constriction diameter Dc2, a second venturi outlet cone 467 with a second venturi outlet angle Ao2, and a second venturi outlet 469 with a second venturi outlet Do2.

Those skilled in the art will appreciate that the venturi inlet angle Ai1, Ai2 may be the smaller than, equal to, or larger than the venturi outlet angle Ao1, Ao2. Further, those skilled in the art will appreciate that the first venturi angles Ai1, Ao1 may smaller than, equal to, or larger than the second venturi angles Ai2, Ao2.

The first venturi throat 421 may have a first venturi throat length Lt1 and the second venturi throat 461 may have a second venturi throat length Lt2. Those skilled in the art will appreciate that first venturi throat length Lt1 may be the smaller than, equal to, or larger than the second venturi throat length Lt2.

As in MPFM 400, in one or more embodiments, the first venturi outlet 429, the sensor tube 441, and the second venturi inlet 463 may be regions of the same tube located between the first venturi 420 and the second venturi. In one or more embodiments, the first venturi outlet diameter Do1, the sensor tube diameter Ds, and the second venturi inlet diameter Di2 may be essentially equal.

In FIG. 4, apart from the restricted regions of a venturi, the diameter of the MPFM 400 is essentially constant. As in FIG. 4, in one or more embodiments, the first venturi inlet diameter Di1 and outlet diameters Do1, the sensor tube diameter Ds, and the second venturi inlet and outlet diameters Di2, Do2 may be essentially equal. In one or more embodiments, first venturi inlet diameter Di1, the first venturi outlet diameter Do1, the sensor tube diameter Ds, the second venturi inlet diameter Di2, and the second venturi outlet diameter Do2 may be the same or different. In one or more embodiments, the first venturi outlet diameter Do1, the sensor tube diameter Ds, and the second venturi inlet diameter Di2 may be essentially equivalent but may have a value different than the first venturi inlet diameter Di1, the second venturi outlet diameter Do2, or both.

The first venturi throat 421 may have a first venturi constriction diameter Dc1. Second venturi throat 461 may have a second venturi constriction diameter Dc2. In FIG. 4, first venturi constriction diameter Dc1 is smaller than second venturi constriction diameter Dc2. In one or more embodiments, first venturi constriction diameter Dc1 may be smaller than second venturi constriction diameter Dc2 (as in FIG. 4) or may be larger than second venturi constriction diameter Dc2.

In one or more embodiments, the smaller constriction diameter (such as first venturi constriction diameter Dc1 in FIG. 4) may be between 10 mm and 70 mm (such as between 15 and 40 mm, between 15 mm and 30 mm, etc.). In one or more embodiments, a ratio between the smaller constriction diameter (such as first venturi constriction diameter Dc1 in FIG. 4) and the inlet diameter (such as first venturi inlet diameter Di1 in FIG. 4) may be between 0.10 and 0.70 (such as between 0.15 and 0.40, between 0.15 and 0.30, etc.). In one or more embodiments, the larger constriction diameter (like second venturi constriction diameter Dc2 in FIG. 4) may be between 40 mm and 90 mm (such as between 50 and 90 mm, between 50 mm and 65 mm, etc.). In one or more embodiments, a ratio between the larger constriction diameter (like second venturi constriction diameter Dc2 in FIG. 4) and the inlet diameter (such as second venturi inlet diameter Di2 in FIG. 4) may be between 0.40 and 0.90 (such as between 0.50 and 0.90, between 0.50 and 0.65, etc.). In one or more embodiments, a ratio between the smaller venturi constriction diameter (such as first venturi constriction diameter Dc1 in FIG. 4) and larger constriction diameter (like second venturi constriction diameter Dc2 in FIG. 4) may be between 0.10 and 0.80 (such as between 0.30 and 0.75, between 0.40 and 0.75, between 0.40 and 0.60, etc.).

In FIG. 4, the first venturi 420 includes a first venturi inlet pressure sensor 433 that measures a first venturi inlet pressure Pi1; a first venturi outlet pressure sensor 439 that measures a first venturi outlet pressure Po1; and a first venturi constriction pressure sensor 432 that measures a first venturi constriction pressure Pc1. The second venturi 460 includes a second venturi inlet pressure sensor 473 that measures a second venturi inlet pressure Pi2; a second venturi outlet pressure sensor 479 that measures a second venturi outlet pressure Po2; and a second venturi constriction pressure sensor 472 that measures a second venturi constriction pressure Pc2. The sensor tube includes a sensor tube pressure sensor 443 that measures a sensor tube pressure Ps.

In one or more embodiments, the first outlet pressure Po1, the second inlet pressure Pi2, and the sensor tube pressure Ps may be approximately equivalent.

One or more embodiments of the MPFM 400 may include some combination of the first venturi inlet pressure sensor 433, the first venturi constriction pressure sensor 432, the first venturi outlet pressure sensor 439, the second venturi inlet pressure sensor 473, the second venturi constriction pressure sensor 472, the second venturi outlet pressure sensor 479, and the sensor tube pressure sensor 443. One or more embodiments of the MPFM 400 may include fewer pressure sensors than depicted in FIG. 4. One or more embodiments of the MPFM 400 may include the first venturi inlet pressure sensor 433; the first venturi outlet pressure sensor 439, the second venturi inlet pressure sensor 473, and/or the sensor tube pressure sensor 443; and the second venturi outlet pressure sensor 479. In such an embodiment, the first pressure change across the first venturi 420 may reflect the first venturi inlet pressure sensor 433 along with the first venturi outlet pressure sensor 439, the second venturi inlet pressure sensor 473 and/or the sensor tube pressure sensor 443, while the second pressure change across the second venturi 460 may reflect the second venturi outlet pressure sensor 479 along with the first venturi outlet pressure sensor 439, the second venturi inlet pressure sensor 473 and/or the sensor tube pressure sensor 443, and. One or more embodiments of the MPFM 400 may include the first venturi inlet pressure sensor 433, the first venturi constriction pressure sensor 432, the second venturi inlet pressure sensor 473, and the second venturi constriction pressure sensor 472. In such an embodiment, the first pressure change across the first venturi 420 may reflect the first venturi inlet pressure sensor 433 and the first venturi constriction pressure sensor 432, while the second pressure change across the second venturi 460 may reflect the second venturi inlet pressure sensor 473, and the second venturi constriction pressure sensor 472. Such a double venturi MPFM disclosed herein provides a wider range for measuring three phase fluid rates. Over time, the liquid rate decreases in producing oil wells. As a result, a single venturi based MPFM may need to be replaced to accommodate for the lower flowrates. With embodiments disclosed herein, based on the measured pressure across both venturis of the double venturi MPFM, the system is able to automatically detect (without the need to manually switch) the right venturi size and use that venturi for measuring the total flowrate passing through it.

In one or more embodiments, the MPFM 400 may include the tomography control system 490 having the tomography controller 491 that receives the measurements from the gamma ray detector 453, from the pressure sensors associated with the two or more venturis 420, 460, and from any other sensor residing downhole in the wellbore as part of the MPFM 400 or elsewhere in the wellbore.

In one or more embodiments, the pressure sensors 433, 432, 439, 443, 473, 472, 479 of the MPFM 400 including those associated with the first venturi (such as the first venturi inlet pressure sensor 433, the first venturi constriction pressure sensor 432, the first venturi outlet pressure sensor 439, or a combination); the second venturi (such as the second venturi inlet pressure sensor 473, the second venturi constriction pressure sensor 472, the second venturi outlet pressure sensor 479, or a combination); the gamma ray tomograph (the sensor tube pressure sensor 443), or a combination may be communicably connected to tomography controller 491 within tomography control system 490. In one or more embodiments, the pressure sensors 433, 432, 439, 443, 473, 472, 479 of the MPFM 400 may provide pressure data, temperature data, or both, of the multiphase flow 401 to the tomography controller 491. In one or more embodiments, the pressure sensors 433, 432, 439, 443, 473, 472, 479 may generate one or more pressure data signals that are transmitted from the pressure sensors 433, 432, 439, 443, 473, 472, 479 to the tomography controller 491. In one or more embodiments, the tomography controller 491 may receive sensor input from the pressure sensors 433, 432, 439, 443, 473, 472, 479 in substantially real time.

In one or more embodiments, the tomography control system 490 includes one or more processors and a computer-readable medium that stores computer instructions executable by the one or more processors. The tomography control system 490 includes the tomography controller 491 that interprets the received measurement data into outputs relating to fluid characteristics of the multiphase mixture 401, such as volume fraction, mass fraction, flowrate, density, temperature, pressure, viscosity, a combination of these characteristics, or other characteristics.

In one or more embodiments, a second venturi may be added to an existing MPFM system that already has one venturi. For example, a second, smaller venturi may be installed in the existing MPFM to accommodate a wider range of flowrate using the same meter. Thus, the MPFM system may be able to operate within a larger range of multiphase mixture flowrates. More specifically, the smaller venturi may be installed to accommodate lower rate wells, in which overall flowrates have reduced over time. Advantageously, such a double venturi MPFM leads to better data quality for lower rate wells, and also saves in the cost to replace/upgrade the existing MPFMs when liquid rates decrease at the producing wells or in adding second single venturi meter to the producing well. Furthermore, a supplemental venturi system would allow a commercially-available gamma ray tomography-based MPFM to be accurate over a larger range of flowrates.

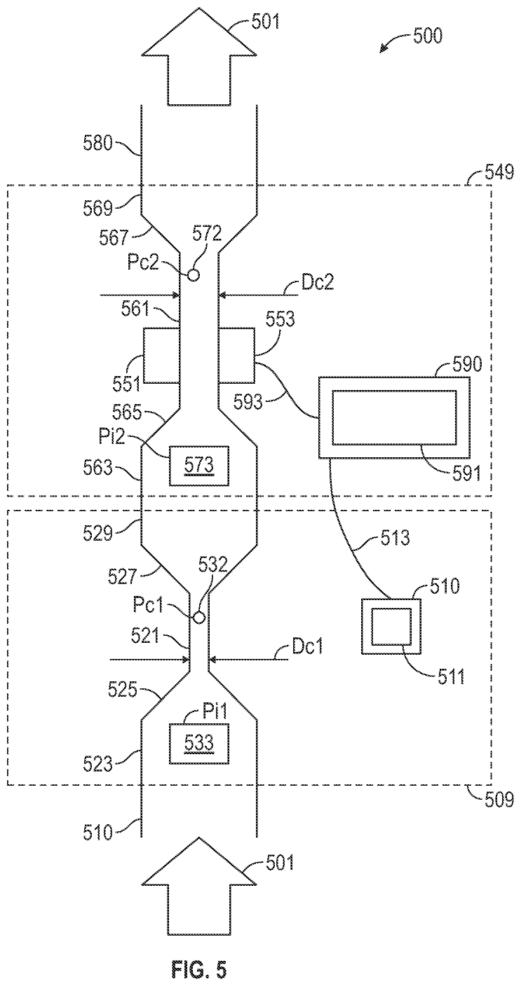

FIG. 5 depicts an embodiment of an MPFM 500. Included in MPFM 500 is a supplemental venturi 509 and a gamma ray tomography-based MPFM 549. Here, the embodiment is configured such that a supplemental venturi 509 may be placed in-line with a commercially-available gamma ray tomography-based MPFM 549 to increase the range of accurately-measured flowrates.

Supplemental venturi 509 includes a first venturi inlet 523, a first venturi inlet cone 525, a first venturi throat 521 having a constriction diameter Dc1, a first venturi outlet cone 527, and a first venturi outlet 529. Supplemental venturi 509 also includes a first venturi inlet pressure sensor 533 that measures a first venturi inlet pressure Pi1, and a first venturi constriction pressure sensor 532 that measures a first venturi constriction pressure Pc1 for calculating a first multiphase fluid flowrate, as detailed previously. Finally, supplemental venturi 509 includes a supplemental MPFM control system 510 having a supplemental tomography controller 511.

Gamma ray tomography-based MPFM 549 also includes a second venturi inlet 563; a second venturi inlet cone 565; a second venturi throat 561 having a constriction diameter of Dc2; a second venturi outlet cone 567; and a second venturi outlet 469 with a second venturi outlet Do2. Gamma ray tomography-based MPFM 549 also includes a gamma ray source 551 and a gamma ray detector 553 located around second venturi throat 561 that also serves as a sensor tube. Further, gamma ray tomography-based MPFM 549 includes a second venturi inlet pressure sensor 573 and a second venturi constriction pressure sensor 572 for calculating a second multiphase fluid flowrate, as detailed previously.

A multiphase mixture 501 enters MPFM 500 via a fluid inlet 510 and ultimately exits the MPFM 500 via a fluid outlet 580. Fluidly connected between fluid inlet 510 and fluid outlet 580 are the supplemental venturi 509 and the gamma ray tomography-based MPFM 549.

In FIG. 5, gamma ray tomography-based MPFM 549 includes a tomography control system 590 (including a tomography controller 591) that is connected to gamma ray detector 553 by data connection 593. Further, supplemental venturi 509 includes a supplemental MPFM control system 510 having a supplemental tomography controller 511 connected to tomography control system 590 by a secondary data connection 513. Some embodiments, as depicted in FIG. 5, may include a separate supplemental MPFM control system 510 connected to tomography control system 590 by a secondary data connection 513. Some embodiments of an MPFM 500 that includes supplemental venturi 509 and gamma ray tomography-based MPFM 549 may lack a separate supplemental MPFM control system 510, so the functions of supplemental tomography controller 511 may be performed by tomography controller 591. In some embodiments, tomography controller 591 may be updated or augmented to perform the additional functions performed by supplemental tomography controller 511.

In some embodiments, supplemental tomography controller 511 may receive data from tomography controller 591, including a gamma ray data signal and a pressure data signal. Additionally, in some embodiments, supplemental tomography controller 511 may receive pressure data from first venturi inlet pressure sensor 533 and first venturi constriction pressure sensor 532. By combining the data from gamma ray tomography-based MPFM 549 and supplemental venturi 509, supplemental tomography controller 511 may determine a multiphase flowrate as detailed further. Thus, in some embodiments, supplemental venturi 509 may be installed in line with gamma ray tomography-based MPFM 549 (such as an existing, commercial MPFM) to increase the range where the calculated multiphase flowrate is accurate.

Supplemental tomography controller 511 may be upflow or downflow from gamma ray tomography-based MPFM 549. Second venturi throat 561 constriction diameter Dc2 may be larger or smaller than first venturi throat 521 constriction diameter Dc1. Pressure sensors in supplemental tomography controller 511 and gamma ray tomography-based MPFM 549 may be located in any location depicted in FIG. 4. While in FIG. 5, both supplemental tomography controller 511 and gamma ray tomography-based MPFM 549 have “throat-type,” supplemental tomography controller 511 and gamma ray tomography-based MPFM 549 may include any venturi type discussed previously. While not depicted in FIG. 5, the lengths and angles of the venturi within supplemental tomography controller 511 and gamma ray tomography-based MPFM 549 may be measured as discussed previously.

In some embodiments, gamma ray source 151, 451, 551 and gamma ray detector 153, 453, 553 may be located around second venturi throat 161, 461, 561 (as in FIG. 5), around a first venturi throat 121, 421, or around a sensor tube 141, 441 that is not within a venturi (as in FIGS. 1 and 4). Locating the gamma ray source 151, 451, 551 and gamma ray detector 153, 453, 553 within a first or second venturi 120, 420, 520, 160, 460, 560 may help make the overall MPFM 100, 400, 500 smaller and/or may decrease the cross-sectional area through which the gamma rays are transmitted before detection.

FIG. 6 is a flow chart summarizing the method for using MPFM 400 to determine the component flowrates of the multiple component phases within the multiphase mixture. Specifically, FIG. 6 illustrates the process by which component flowrates and/or an overall flowrate of the multiphase mixture are calculated at the time the fluid flows through the MPFM as shown in FIGS. 1 and 4, for example. As described above, embodiments disclosed herein provide a multi-venturi MPFM capable of providing a wider range of flowrate to measure (e.g., high and low range rate measurement). Based on the measured pressure across the ventures, the system should be able automatically (without the need to manually switch) to detect the right venturi size and use that detected venturi for measuring the total rate passing through it. One or more blocks in FIG. 6 may be performed by one or more components as described above in FIGS. 1-4 (e.g., pressure sensors, processor, etc.). One of ordinary skill in the art will appreciate that some or all of the blocks may be executed in a different order, may be combined or omitted, and some or all of the blocks may be executed in parallel. Furthermore, the blocks may be performed actively or passively.

In step S1, the multiphase mixture flows through the MPFM from the fluid inlet to the fluid outlet. Specifically, the multiphase mixture enters the fluid inlet, traverses the first venturi, the gamma ray tomograph, and the second venturi, and flows out of the fluid outlet.

In step S2, using the pressure sensors of the MPFM, a first pressure change is determined across the first venturi and a first venturi multiphase flowrate R1 is calculated.

Specifically, in one or more embodiments, the first venturi inlet pressure Pi1, the first venturi outlet pressure Po1, the first venturi constriction pressure Pc1, the sensor tube pressure Ps, or a combination thereof may be used to calculate a first multiphase pressure change. Using the equations discussed previously, in one or more embodiments, the tomography controller may calculate a first venturi multiphase flowrate R1 from a first pressure change across the first venturi using one or more first venturi pressure data signals.

In step S3, using the pressure sensors of the MPFM, a second pressure change is determined across the second venturi and a second venturi multiphase flowrate R2 is calculated.

In one or more embodiments, the second venturi inlet pressure Pi2, the second venturi outlet pressure Po2, the second venturi constriction pressure Pc2, the sensor tube pressure Ps, or a combination may be used to calculate a second pressure change across the second venturi. Using the equations discussed previously, in one or more embodiments, the tomography controller may calculate a second venturi multiphase flowrate R2 from a second pressure change across a second venturi using one or more second venturi pressure data signals.

Step S4 involves calculating a multiphase flowrate Rm of the multiphase mixture flowing through the MPFM based on the first venturi multiphase flowrate R1 determined in S2 and the second venturi multiphase flowrate R2 determined in S3.

In one or more embodiments, tomography controller 491 may use the first venturi multiphase flowrate R1 and the second venturi multiphase flowrate R2 to calculate a multiphase flowrate Rm.

In one or more embodiments, a correct value for the multiphase flowrate Rm may be equal to the first venturi multiphase flowrate R1 at some real flowrates and equal to the second venturi multiphase flowrate R2 at other real flowrates. In one or more embodiments, the tomography controller 491 may apply a predetermined pressure change threshold or predetermined multiphase flowrate threshold to select the first or second venturi multiphase flowrates R1, R2 when calculating the multiphase flowrate Rm. In some embodiments, tomography controller 491 may apply a predetermined first pressure/flowrate threshold to measurements from the first venturi and a predetermined second pressure/flowrate threshold to measurements from the second venturi.

In one or more embodiments, the multiphase flowrate Rm determined using the smaller-diameter venturi may be more accurate at lower flowrates, such as flowrates between 400 BPD and 4,000 BPD, while the multiphase flowrate Rm determined using the larger-diameter venturi may be more accurate at higher flowrates, such as flowrates between 4,000 BPD and 14,000 BPD. Thus, in one or more embodiments where the first venturi constriction diameter is smaller than the second venturi constriction diameter, the multiphase flowrate Rm determined using the first multiphase flowrate R1 may be more accurate at flowrates between 400 BPD and 4,000 BPD, while the multiphase flowrate Rm determined using the second multiphase flowrate R2 may be more accurate at flowrates between 4,000 BPD and 14,000 BPD.

Every Venturi has a threshold pressure drop across it where if that pressure is smaller than the threshold it will not be detected by the pressure sensors. However, if the rate is high rate and the throat is small, the flow regime will be turbulent (not laminar) and the measured pressure drop will not be representative thus the rate will have accuracy issues. In some embodiments, a multiphase flowrate calculated using an oversized, large diameter venturi may underestimate or overestimate the actual multiphase flowrate due to factors such as a small pressure change. Similarly, a multiphase flowrate calculated using an undersized, small diameter venturi may be in a turbulent flow regime (as opposed to laminar flow regime). Such a undersized venturi may underestimate or overestimate the actual flowrate due to factors such as turbulence.

The productivity and thus the multiphase flowrate for a well typically decreases over time on average, as a formation becomes less productive. Furthermore, in some embodiments, the larger diameter venturi may be appropriately sized for the initial flowrate. Thus, in some embodiments, larger diameter venturi may be used to calculate an accurate multiphase flowrate early in a wells life when the multiphase flowrate is highest. Furthermore, since the larger diameter venturi is less accurate at low flowrates, the smaller diameter venturi may be used to calculate an accurate multiphase flowrate later in a wells life as the multiphase flowrate decreases.

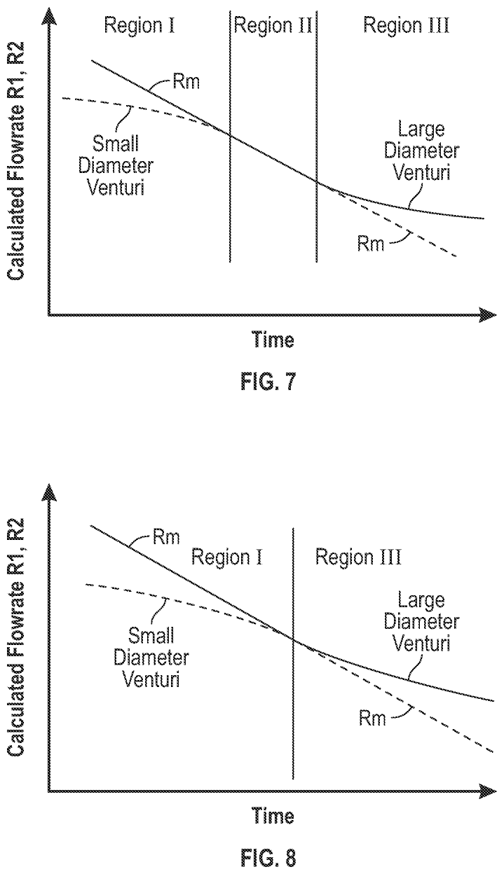

Consider FIGS. 7 and 8 which both depict schematic graphs of calculated flowrate as a function of time (meaning production time). In both idealized graphs, the actual flowrate follows a linear decrease. However, as discussed above, at high flowrates early in the well lifetime, the flowrate calculated using the small diameter venturi may not reflect the true flowrate. Similarly, at low flowrates late in the well lifetime, the flowrate calculated using the large diameter venturi may not reflect the true flowrate. Here, the assumption is that the small diameter venturi underestimates the flowrate at high flowrates and the large diameter venturi overestimates the flowrate at low flowrates.

The idealized graph depicted in FIG. 7 is divided into three regions: Region I, where the large diameter venturi is accurate and the small diameter venturi underestimates the flowrate; Region II, where the calculated flowrates using the large and small diameter venturis are equal and both result in accurate measures; and Region III, where the small diameter venturi is accurate and the large diameter venturi overestimates the flowrate.

Thus, in some embodiments as depicted in FIG. 7, a tomography controller may compare the first and second venturi multiphase flowrates R1, R2 to calculate the multiphase flowrate Rm.

Consider an MPFM 400 where constriction diameter Dc2 of second venturi 460 is larger than constriction diameter Dc1 of first venturi 420, as depicted in FIG. 4. In Region I, at high flowrates tomography controller 491 may equate the multiphase flowrate Rm with the second venturi multiphase flowrate R2.

In Region II, as the first and second venturi multiphase flowrates R1, R2 converge, the multiphase flowrate Rm may equal a combination of the first and second venturi multiphase flowrates R1, R2 such as an average.

Finally, in Region III, the second venturi multiphase flowrate R2 and the first venturi multiphase flowrate R1 diverge. Specifically, when second venturi multiphase flowrate R2 becomes greater than the first venturi multiphase flowrate R1 and/or the difference between the first and second venturi multiphase flowrates R1, R2 increases beyond a predetermined threshold, tomography controller 491 may equate the multiphase flowrate Rm with the first venturi multiphase flowrate R1.

One having ordinary skill in the art will appreciate how to determine appropriate predetermined thresholds for equivalence, divergence, and convergence between first and second venturi multiphase flowrates R1, R2.

Consider the schematic graph depicted in FIG. 8. Here, there is no significant region where the first and second venturi multiphase flowrates R1, R2 converge. However, the first and second venturi multiphase flowrates R1, R2 are equivalent at a single point where the two lines cross. In some embodiments, such a crossing may indicate Region I and Region III. As detailed above, the multiphase flowrate Rm may be calculated in Region I and Region III from the first and second venturi multiphase flowrates R1, R2.

In some embodiments, one or more mathematical functions may be used to determine when either the first or the second venturi multiphase flowrates R1, R2 may be relied on to calculate the multiphase flowrate Rm. For example, in some embodiments, the transition point between Region I and Region III may be where the second time derivative of the calculated flowrate for the first and/or second venturi multiphase flowrates R1, R2 equals zero or changes signs.

One having ordinary skill in the art will appreciate how to mathematically determine the transition point between Regions I and II; between Regions II and III; and between Regions I and III. Further, one having ordinary skill in the art will appreciate how the efficiency of an electric submersible pump (ESP) decreases when the ESP operates outside of a specific range of multiphase flowrates. Specifically, if the ESP is properly sized for the initial multiphase flowrate, the efficiency decreases as the multiphase flowrate decreases. Thus, one of ordinary skill can estimate the multiphase flowrate using pressure readings from the ESP to calculate the total dynamic head per stage.

In some embodiments, tomography controller 491 may receive input including pressure data from the ESP to estimate the multiphase flowrate. In some embodiments, tomography controller 491 may use the multiphase flowrate estimated from the ESP to determine whether to rely on the first or second venturi multiphase flowrate R1, R2 when calculating a multiphase flowrate Rm. In some embodiments, tomography controller 491 may apply a total dynamic head threshold to determine whether to rely on the first or second venturi multiphase flowrate R1, R2 when calculating a multiphase flowrate Rm.

Step S5 combines the multiphase flowrate Rm and the gamma ray tomography data Gd to determine an individual flowrate Ri of each of the component phases in the multiphase mixture 401. More specifically, in one or more embodiments, the tomography controller 491 uses the multiphase flowrate Rm and the gamma ray tomography data Gd to determine the individual flowrates Ri of each of the component phases in the multiphase mixture 401.

In one or more embodiments, some fraction of the gamma rays generated by the gamma ray generator 451 may be detected by the gamma ray detector 453. In one or more embodiments, the gamma ray detector 453 may detect some fraction of the gamma rays generated by the gamma ray generator 451. In one or more embodiments, the gamma ray detector 453 may generate a gamma ray data signal Gd reflecting the gamma rays detected and transmit gamma ray signal Gd to the tomography controller 491. In one or more embodiments, the tomography controller 491 may receive sensor input from the gamma ray detector 453 in substantially real time.

In one or more embodiments, the MPFM 400 may further include a temperature sensor, or other sensors that provide data to the tomography controller 491. In one or more embodiments, the tomography controller 491 receives data input from additional sensors that provide one or more of pressure, temperature, viscosity, density, or other characteristics.

One having ordinary skill in the art will appreciate how to combine the multiphase flowrate Rm with the gamma ray tomography data Gd and additional sensor readings to determine the individual flowrates Ri of each of the component phases in the multiphase mixture 401.

Unless defined otherwise, all technical and scientific terms used have the same meaning as commonly understood by one of ordinary skill in the art to which these systems, apparatuses, methods, processes and compositions belong.

It is noted that one or more of the following claims utilize the term “where” or “in which” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.” For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

As used in the Specification and appended Claims, the singular forms “a”, “an”, and “the” include plural references unless the context clearly indicates the contrary. The verb “comprises” and its conjugated forms should be interpreted as referring to elements, components or steps in a non-exclusive manner. The referenced elements, components or steps may be present, utilized or combined with other elements, components or steps not expressly referenced.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Ranges may be expressed as from about one particular value to about another particular value, inclusive. When such a range is expressed, it is to be understood that another embodiment is from the one particular value to the other particular value, along with all particular values and combinations thereof within the range.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims

1.-12. (canceled)

13. A method for operating a multi-phase flow meter (MPFM) to determine component flowrates of multiple component phases within a multiphase mixture having a multiphase flowrate, the method comprising:
flowing the multiphase mixture through the MPFM into a fluid inlet, through a first venturi, a gamma ray tomograph, and a second venturi, and out a fluid outlet of the MPFM;
calculating a first venturi multiphase flowrate using a first pressure change measured across the first venturi;
calculating a second venturi multiphase flowrate using a second pressure change measured across the second venturi;
determining the multiphase flowrate using the first and the second venturi multiphase flowrates; and
determining the component flowrates of the multiple component phases using the multiphase flowrate and a gamma ray data signal generated by a gamma ray detector of the MPFM.

14. The method according to claim 13, wherein a range of measurement of the multiphase flowrate by the MPFM is between 500 barrels per day (BPD) and 14,000 BPD.

15. The method according to claim 13, wherein determining the multiphase flowrate further comprises:
applying a predetermined flowrate threshold to select the first or the second venturi multiphase flowrates to determine the multiphase flowrate.

16. The method according to claim 13, wherein determining the multiphase flowrate further comprises:
applying a predetermined pressure change threshold to select the first or the second venturi multiphase flowrates to determine the multiphase flowrate.

17. The method according to claim 13, wherein determining the multiphase flowrate further comprises:
determining a difference between the first venturi multiphase flowrate and the second venturi multiphase flowrate; and
using the difference to select between the first venturi multiphase flowrate and the second venturi multiphase flowrate to determine the multiphase flowrate.

18. The method according to claim 13, wherein determining the multiphase flowrate further comprises:
equating the multiphase flowrate with one of the first or the second multiphase flowrate reflecting a larger constriction diameter; and
equating the multiphase flowrate with an other of the first or the second multiphase flowrate after the first and the second multiphase flowrates diverge.

19. The method according to claim 13, wherein determining the multiphase flowrate further comprises:
equating the multiphase flowrate with one of the first or the second multiphase flowrate reflecting a larger constriction diameter; and
equating the multiphase flowrate with an other of the first or the second multiphase flowrate after the first and the second multiphase flowrates converge.

20. The method according to claim 13, wherein determining the multiphase flowrate further comprises:
applying input from an electric submersible pump fluidly connected to the MPFM to select the first or the second multiphase flowrate.
